(19) United States
(12) Patent Application Publication
(10) Pub. No.: US 2017/0355176 A1
(43) Pub. Date: Dec. 14, 2017

(54) GLASS-POLYMER LAMINATES AND PROCESSES FOR FORMING THE SAME

(71) Applicant: Corning Incorporated, Corning, NY (US)

(72) Inventors: Brittany Marie Fischer, Philadelphia, PA (US); Adam Joseph Fusco, Corning, NY (US); Karthik Gopalakrishnan, Corning, NY (US); Andrew Charles Gorges, Addison, NY (US); Michael William Price, Corning, NY (US); James Ernest Webb, Corning, NY (US)

(21) Appl. No.: 15/527,508

(22) PCT Filed: Nov. 17, 2015
(86) PCT No.: PCT/US15/61012

§ 371 Date: May 17, 2017

Related U.S. Application Data
(60) Provisional application No. 62/080,764, filed on Nov. 17, 2014.

(51) Int. Cl. B32B 17/06; B32B 37/12; B32B 17/10

(52) U.S. Cl. CPC B32B 17/064; B32B 17/10018; B32B 17/10807; B32B 37/12; B32B 2309/105

(57) ABSTRACT

A glass-polymer laminate includes a glass layer with a thickness of at most about 300 μm and a polymer layer laminated to the glass layer. At all temperatures within a temperature range of about 16 C to about 32 C, the glass layer has a compressive stress and the glass-polymer laminate has a bow flattening force of at most about 150 N. A method includes laminating a glass layer to a polymer layer with an adhesive at a lamination temperature to form a glass-polymer laminate. The glass layer has a thickness of at most about 300 μm. The lamination temperature is sufficiently high that, at all temperatures within a temperature range of about 16 C to about 32 C, the glass layer has a compressive stress. The lamination temperature is sufficiently low that, at all temperatures within the temperature range, the glass-polymer laminate has a bow flattening force of at most about 150 N.

This application claims the benefit of priority to U.S. Application No. 62/080,764 filed Nov. 17, 2014 on the content of which is incorporated herein by reference in its entirety.

### BACKGROUND

### 1. Field

This disclosure relates to glass-polymer laminates, and more particularly to glass-polymer laminates with determined stress and bowing characteristics that enable such glass-polymer laminates to be cut and installed without breakage and to processes and apparatuses for forming such glass-polymer laminates.

### 2. Technical Background

Laminated glass structures may be used as components in the fabrication of various appliances, automobile components, architectural structures, or electronic devices. For example, laminated glass structures may be incorporated as cover glass for various end products such as refrigerators, backsplashes, decorative glazing, or televisions. However, it may be difficult to cut and install the laminated glass structures in the field (e.g., at the place of installation) without breaking the glass layer. For example, it would be desirable to enable cutting and installation of laminated glass structures over a wide range of temperatures.

### SUMMARY

Disclosed herein are glass-polymer laminates and methods for forming the same.

Disclosed herein is a glass-polymer laminate comprising a glass layer comprising a thickness of at most about 300 μm and a polymer layer laminated to the glass layer. At all temperatures within a temperature range of about 16° C. to about 32° C., the glass layer comprises a compressive stress and the glass-polymer laminate comprises a bow flattening force of at most about 150 N.

Disclosed herein is a method comprising laminating a glass layer to a polymer layer with an adhesive at a lamination temperature to form a glass-polymer laminate. The glass layer comprises a thickness of at most about 300 μm. The lamination temperature is sufficiently high that, at all temperatures within a temperature range of about 16° C. to about 32° C., the glass layer comprises a compressive stress. The lamination temperature is sufficiently low that, at all temperatures within the temperature range of about 16° C. to about 32° C., the glass-polymer laminate comprises a bow flattening force of at most about 150 N.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a cross-sectional view of one exemplary embodiment of a glass-polymer laminate.

FIG. 2 is a graphical illustration of the stress in the glass layer of an exemplary glass-polymer laminate in the direction of the short axis as a function of position along the short centerline of the glass-polymer laminate at multiple temperatures.

FIG. 3 is a graphical illustration of the stress in the glass layer of an exemplary glass-polymer laminate in the direction of the long axis as a function of position along the short centerline of the glass-polymer laminate at multiple temperatures.

FIG. 4 is a graphical illustration of the bow in an exemplary glass-polymer laminate as a function of ΔT from the lamination temperature.

FIG. 5 is a graphical illustration of the bow flattening force of an exemplary glass-polymer laminate as a function of ΔT from the lamination temperature.

FIG. 6 is a graphical illustration of the temperature limits of an exemplary glass-polymer laminate and the relationship between the temperature limits and stress and bowing limits.

FIG. 7 is a graphical illustration of the maximum compressive stress in the glass layer of an exemplary glass-polymer laminate along each of the long axis and the short axis as a function of ΔT from the lamination temperature.

FIG. 8 is a graphical illustration of the number of cracks per part during cutting of an exemplary glass-polymer laminate as a function of ΔT from the lamination temperature.

FIG. 9 is a graphical illustration of the stress in the glass layer of an exemplary glass-polymer laminate in the direction of the short axis as a function of position along the short centerline of the glass-polymer laminate at the different sizes of the glass-polymer laminate.

FIG. 10 is a graphical illustration of the stress in the glass layer of an exemplary glass-polymer laminate in the direction of the long axis as a function of position along the short centerline of the glass-polymer laminate at the different sizes of the glass-polymer laminate.

FIG. 11 is a graphical illustration comparing the bow of exemplary glass-polymer laminates measured at 22° C. as a function of lamination temperature for two different sizes of glass-polymer laminates.

FIG. 12 is a graphical illustration comparing modeled bow of glass-polymer laminates as a function of ΔT from the lamination temperature for two different sizes of glass-polymer laminates.

FIG. 13 is a graphical illustration comparing modeled bow flattening force measured at 22° C. as a function of lamination temperature for two different sizes of glass-polymer laminates.

FIG. 14 is a graphical illustration comparing modeled bow flattening force of glass-polymer laminates as a function of ΔT from the lamination temperature for two different sizes of glass-polymer laminates.

FIG. 15 is a graphical illustration comparing modeled bow of glass-polymer laminates as a function of ΔT from the lamination temperature for two different thicknesses of the polymer layer.

FIG. 16 is a graphical illustration comparing modeled maximum stress of glass layers of glass-polymer laminates as a function of ΔT from the lamination temperature for two different thicknesses of the polymer layer.

FIG. 17 is a line drawing reproduction of a photograph showing a finished cut formed by an exemplary cutting process and resulting exit cracking.

FIG. 18 is a line drawing reproduction of a photograph showing an exemplary notch formed in a glass-polymer laminate.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

In various embodiments, a glass-polymer laminate comprises a glass layer having a thickness of at most about 300 μm and a polymer layer laminated to the glass layer. The properties of the glass layer, the polymer layer, and/or the lamination process are controlled such that at all temperatures within a temperature range of about 16° C. to about 32° C., the glass layer comprises a compressive stress and the glass-polymer laminate comprises a bow flattening force of at most about 150 N.

As used herein, and unless indicated otherwise, the term “coefficient of thermal expansion” refers to the average coefficient of thermal expansion (CTE) of a material or layer over a temperature range of 20° C. to 300° C. for a glass material or layer and 0° C. to 40° C. for a polymer material or layer.

As used herein the term “bow” refers to the amount of curvature exhibited by a bowed glass-polymer laminate. The bow is determined by placing the bowed glass-polymer laminate on a flat surface and measuring the maximum distance between the flat surface and the largest displacement of the glass-polymer laminate from the flat surface.

As used herein the term “bow flattening force” refers to the minimum force sufficient to urge a bowed glass-polymer laminate into a substantially planar configuration. The bow flattening force is determined by applying an increasing force to the bowed glass-polymer laminate (e.g., by placing weights on the glass-polymer laminate) until the glass-polymer laminate is in the substantially planar configuration. The force is applied at the edges of the glass-polymer laminate that are farthest from the flat surface when determining the bow. For example, if the glass-polymer laminate is bowed about a long axis, the force is applied to the long edges of the glass-polymer laminate. Alternatively, if the glass-polymer laminate is bowed about a short axis, the force is applied to the short edges of the glass-polymer laminate. The force is applied symmetrically to opposing edges of the glass-polymer laminate. For example, equal amounts of weight can be placed on opposing long edges or opposing short edges of the glass-polymer laminate to apply the force symmetrically.

The glass-polymer laminates described herein can be used for architectural applications. For example, a glass-polymer laminate can be used as a decorative panel (e.g., a backsplash or a wall panel) and/or a functional panel (e.g., a white board or projection screen). In such applications, it can be beneficial to produce the glass-polymer laminate at a production location and then cut the glass-polymer laminate to size on site at the installation location (i.e., in the field). It also can be beneficial to be able to cut and install the glass-polymer laminate over a wide range of temperatures. For example, the temperature on site at the installation location may be substantially different at different times during the year (e.g., summer versus winter) or at different geographic locations, and it can be beneficial to be able to cut and install the glass-polymer laminate at various times during the year and at various geographic locations without breaking the glass-polymer laminate or a portion thereof (e.g., the glass layer).

Generally, the CTE of the glass layer and the CTE of the polymer layer are substantially different. For example, the CTE of the glass layer is substantially less than the CTE of the polymer layer as described herein. The CTE mismatch between the glass layer and the polymer layer can result in two effects that can limit the temperature range for cutting and installing the glass-polymer laminate and/or the operational life of the glass-polymer laminate.

The first effect of the CTE mismatch is the stress in the glass layer. At the lamination temperature, the stresses in the glass layer and the polymer layer are zero. As the temperature of the glass-polymer laminate is increased above the lamination temperature, tensile stress in the glass layer increases until the glass fractures. This limits the maximum temperature at which the glass-polymer laminate can be cut and also the maximum temperature for the life of the glass-polymer laminate after finishing.

The second effect of the CTE mismatch is the bow of the glass-polymer laminate. The bow is most evident at temperatures below the lamination temperature, where the glass is in compression. As the temperature of the glass-polymer laminate decreases below the lamination temperature, an increasing amount of force is required to flatten the glass-polymer laminate. In other words, as the temperature of the glass-polymer laminate decreases below the lamination temperature, the bow flattening force of the glass-polymer laminate increases. If a pressure sensitive adhesive is used to hold the glass-polymer laminate in place against a flat surface while a permanent adhesive is allowed to cure (e.g., during installation), the bowing of the glass-polymer laminate can pull the temporary adhesive from the flat surface and prevent proper adherence of the permanent adhesive. Lower temperatures also can limit the adhesion of the pressure sensitive adhesive, which further limits the installation process and favors lower bowing induced flattening forces.

It may be beneficial to increase the lamination temperature to avoid an unacceptably high tensile stress in the glass layer at higher cutting temperatures. It also may be beneficial to decrease the lamination temperature to avoid an unacceptably high bow flattening force at lower installation temperatures. Thus, the high temperature cutting limit and low temperature installation limit are competing goals that encourage adjusting the lamination temperature in opposite directions.

The properties of the glass layer and the polymer layer and the lamination process can be controlled as described herein to enable cutting and installation of the glass-polymer laminate over a determined temperature range. For example, in some embodiments, the glass-polymer laminate has a high temperature cutting and installation limit of at least 35° C., a low temperature installation limit of at most 16° C., and/or a low temperature life limit of at most 0° C. as described herein.

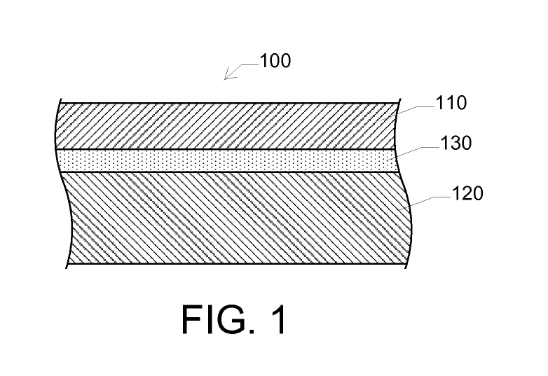

FIG. 1 is a cross-sectional view of one exemplary embodiment of a glass-polymer laminate 100. Glass-polymer laminate 100 comprises a glass layer 110, a polymer layer 120, and an adhesive layer 130 disposed between the glass layer 110 and the polymer layer 120. Thus, polymer layer 120 is laminated to glass layer 110 with adhesive layer 130. In some embodiments, glass-polymer laminate 100 comprises a laminate sheet as shown in FIG. 1. The laminate sheet has a length, a width, and a thickness. The length is the longest dimension, and the thickness is the smallest dimension. Each of the length and the width is substantially larger (e.g., at least one order of magnitude larger) than the thickness. The laminate sheet can be substantially planar (i.e., flat) or non-planar (i.e., curved). In other embodiments, the glass-polymer laminate comprises a three-dimensional (3D) shape. For example, the 3D shape may be formed by molding a laminate sheet in a molding device.

In some embodiments, glass layer 110 comprises a flexible glass layer. Thus, glass layer 110 comprises a thickness of at most about 300 μm, at most about 200 μm, at most about 150 μm, or at most about 100 μm. Additionally, or alternatively, glass layer 110 comprises a thickness of at least about 50 μm. For example, glass layer 110 comprises a thickness of about 150 μm to about 250 μm. Glass layer 110 comprises a glass material, a ceramic material, a glass-ceramic material, or combinations thereof.

Glass layer 110 can be formed using a suitable forming process. For example, glass layer 110 can be formed using a downdraw process such as a fusion process. Forming glass layer 110 using a fusion process can enable the glass layer to have surfaces with superior flatness and smoothness compared to glass sheets produced by other methods. The fusion process is described in U.S. Pat. Nos. 3,338,696 and 3,682,609. Other suitable glass forming processes may include a float process, an updraw process, or a slot draw process. In some embodiments, glass layer 110 comprises anti-microbial properties. For example, glass layer 110 comprises a silver ion concentration at the surface of the glass layer in a range of greater than 0 μg/cm² to 0.047 μg/cm² as described in U.S. Patent Application Publication No. 2012/0034435. Additionally, or alternatively, glass layer 110 is coated with a glaze comprising silver, or otherwise doped with silver ions, to gain the desired anti-microbial properties as described in U.S. Patent Application Publication No. 2011/0081542. Additionally or alternatively, glass layer 110 comprises a molar composition of 50% SiO₂, 25% CaO, and 25% Na₂O to achieve the desired anti-microbial effects.

In some embodiments, polymer layer 120 comprises a thickness of at least about 2 mm, at least about 3 mm, at least about 4 mm, or at least about 5 mm. Additionally, or alternatively, polymer layer 120 comprises a thickness of at most about 10 mm, at most about 9 mm, at most about 8 mm, at most about 7 mm, or at most about 6 mm. For example, polymer layer 120 comprises a thickness of about 2.9 mm to about 6.1 mm, about 3.9 mm to about 6.1 mm, or about 5.1 mm to about 6.1 mm. Polymer layer 120 comprises a polymer material such as, for example, polyethylene terephthalate (PET), polyethylene naphthalate (PEN), ethylene tetrafluoroethylene (ETFE), thermopolymer polyolefin (TPO™—polymer/filler blends of polyethylene, polypropylene, block copolymer polypropylene (BCPP), or rubber), polyester, polycarbonate, polyvinylbuterate, polyvinyl chloride (PVC), polyethylene or substituted polythyelene, polyhydroxybutyrate, polyhydroxyvinyl butyrate, polyvinyl acetylene, transparent thermoplastic, transparent polybutadiene, polycyanoacrylate, cellulose-based polymer, polyacrylate, polymethacrylate, polyvinylalcohol (PVA), polysulphide, polyvinyl butyral (PVB), poly(methyl methacrylate) (PMMA), polysiloxane, or combinations thereof. Polymer layer 120 can be transparent, translucent, or opaque. In some embodiments, polymer layer 120 comprises a color, decorative pattern, or design that is visible through glass layer 110. Polymer layer 120 can comprise single layer or multiple layers laminated together to form the polymer layer. For example, polymer layer 120 can comprise a polymer substrate layer and a decorative film disposed on a surface of the polymer substrate layer such that a decorative color or pattern of the decorative film is visible through glass layer 110.

In some embodiments, adhesive layer 130 comprises a thickness of at least about 10 μm, at least about 20 μm, at least about 30 μm, or at least about 40 μm. Additionally, or alternatively, adhesive layer 130 comprises a thickness of at most about 100 μm, at most about 90 μm, at most about 70 μm, or at most about 60 μm. For example, adhesive layer 130 comprises a thickness of about 25 μm to about 75 μm. Adhesive layer 130 comprises a non-adhesive interlayer, a sheet or film of adhesive, a liquid adhesive, a powder adhesive, a pressure sensitive adhesive, an ultraviolet (UV) curable adhesive, a thermally curable adhesive, another suitable adhesive, or combinations thereof. For example, adhesive layer 130 comprises a low temperature adhesive such as, for example, Norland 68 (cured by UV), 3M OCA 8211 or 8212 (bonded by pressure at room temperature), 3M 4905, OptiClear® adhesive, silicone, acrylate, optically clear adhesive, encapsulant material, polyurethane, or wood glue. Additionally, or alternatively, adhesive layer 130 comprises a higher temperature adhesive such as, for example, DuPont SentryGlas, DuPont PV 5411, Japan World Corporation material FAS, or polyvinyl butyral resin. In some embodiments, adhesive layer 130 comprises one or more functional components such as, for example, a coloring agent, a decoration, a heat or UV resistance agent, or an AR filtration agent. Adhesive layer 130 can be optically clear on cure or opaque. In some embodiments, adhesive layer 130 comprises a sheet or film with or without a color, decorative pattern, or design that is visible through glass layer 110.

Polymer layer 120 can be laminated to glass layer 110 using a suitable lamination process to form glass-polymer laminate 100. For example, polymer layer 120 can be laminated to glass layer 110 using a sheet-to-sheet (S2S) lamination process wherein pressure and/or heat are used to bond the glass layer to the polymer layer using adhesive layer 130. Alternatively, polymer layer 120 can be laminated to glass layer 110 using a roll-to-sheet (R2S) or roll-to-roll (R2R) lamination process wherein pressure is used to bond a continuous ribbon of the glass layer from a supply roll to the polymer layer either as a continuous ribbon from a supply roll or a plurality of individual sheets. The lamination process can be controlled to impart desired properties to glass-polymer laminate as described herein. After lamination, glass-polymer laminate 110 can be cut and/or installed also as described herein.

In some embodiments, the properties (e.g., CTE or elastic modulus) of glass layer 110 and/or polymer layer 120; the dimensions of the glass layer, the polymer layer, and/or glass-polymer laminate 100; and/or the lamination conditions (e.g., lamination temperature) are controlled to enable cutting and installation of the glass-polymer laminate over a temperature range of about 16° C. to about 32° C. For example, at all temperatures within a temperature range of about 16° C. to about 32° C., glass layer 110 comprises a compressive stress and glass-polymer laminate 100 comprises a bow flattening force of at most about 150 N. Additionally, or alternatively, glass-polymer laminate 100 is capable of surviving cutting with a handheld power tool at a cutting temperature of about 32.2° C.

In some embodiments, glass layer 110 comprises a CTE of at least about 0.5×10⁻⁶° C.⁻¹, at least about 1×10⁻⁶° C.⁻¹, at least about 1.5×10⁻⁶° C.⁻¹, at least about 2×10⁻⁶° C.⁻¹, or at least about 2.5×10⁻⁶° C.⁻¹. Additionally, or alternatively, glass layer 110 comprises a CTE of at most about 9×10⁻⁶° C.⁻¹, at most about 8×10⁻⁶° C.⁻¹, at most about 7×10⁻⁶° C.⁻¹, at most about 6×10⁻⁶° C.⁻¹, at most about 5×10⁻⁶° C.⁻¹, or at most about 4×10⁻⁶° C.⁻¹. For example, glass layer 110 comprises a CTE of about 2.7×10⁻⁶° C.⁻¹ to about 3.7×10⁻⁶° C.⁻¹.

In some embodiments, polymer layer 120 comprises a CTE of at least about 20×10⁻⁶° C.⁻¹, at least about 30×10⁻⁶° C.⁻¹, at least about 40×10⁻⁶° C.⁻¹, at least about 50×10⁻⁶° C.⁻¹, at least about 60×10⁻⁶° C.⁻¹, or at least about 70×10⁻⁶° C.⁻¹. Additionally, or alternatively, polymer layer 120 comprises a CTE of at most about 130×10⁻⁶° C.⁻¹, at most about 120×10⁻⁶° C.⁻¹, at most about 110×10⁻⁶° C.⁻¹, at most about 100×10⁻⁶° C.⁻¹, at most about 90×10⁻⁶° C.⁻¹, or at most about 80×10⁻⁶° C.⁻¹. For example, polymer layer 120 comprises a CTE of about 74.5×10⁻⁶° C.⁻¹ to about 75.5×10⁻⁶° C.⁻¹.

In some embodiments, the difference in CTE or CTE mismatch between glass layer 110 and polymer layer 120 is at least about 10×10⁻⁶° C.⁻¹, at least about 20×10⁻⁶° C.⁻¹, at least about 30×10⁻⁶° C.⁻¹, at least about 40×10⁻⁶° C.⁻¹, at least about 50×10⁻⁶° C.⁻¹, at least about 60×10⁻⁶° C.⁻¹, or at least about 70×10⁻⁶° C.⁻¹.

In some embodiments, glass layer 110 and polymer layer 120 comprise thicknesses as described herein with reference to FIG. 1. In such embodiments, glass-polymer laminate 100 comprises a width of at least about 100 mm, at least about 200 mm, at least about 300 mm, at least about 400 mm, at least about 500 mm or at least about 600 mm. Additionally, or alternatively, glass-polymer laminate comprises a width of at most about 1300 mm, at most about 1200 mm, at most about 1100 mm, at most about 1000 mm, at most about 900 mm, or at most about 800 mm. For example, glass-polymer laminate comprises a width of about 640 mm to about 740 mm. In such embodiments, glass-polymer laminate 100 comprises a length of at least about 2000 mm, at least about 2100 mm, at least about 2200 mm, at least about 2300 mm, at least about 2400 mm or at least about 2500 mm. Additionally, or alternatively, glass-polymer laminate comprises a length of at most about 3200 mm, at most about 3100 mm, at most about 3000 mm, at most about 2900 mm, at most about 2800 mm, or at most about 2700 mm. For example, glass-polymer laminate comprises a length of about 2570 mm to about 2670 mm.

In some embodiments, glass layer 110 is laminated to polymer layer 120 with adhesive layer 130 at a lamination temperature to form glass-polymer laminate 100. The lamination temperature is sufficiently high that, at all temperatures within a temperature range of about 16° C. to about 32° C., glass layer 110 comprises a compressive stress. The lamination temperature is sufficiently low that, at all temperatures within the temperature range of about 16° C. to about 32° C., glass-polymer laminate 100 comprises a bow flattening force of at most about 150 N. In some embodiments, the lamination temperature is at least about 30° C. or at least about 33° C. Additionally, or alternatively, the lamination temperature is at most about 45° C., at most about 40° C., or at most about 37° C. For example, the lamination temperature is about 30° C. to about 45° C., about 30° C. to about 40° C., or about 33° C. to about 37° C.

In some embodiments, glass-polymer laminate 100 is cut with a handheld power tool at a cutting temperature that is less than the lamination temperature. For example, the handheld power tool comprises a router or a saw (e.g., a table saw). Cutting glass-polymer laminate 100 at the cutting temperature below the lamination temperature can help to ensure that glass layer 110 is in compression during the cutting and avoid breaking the glass layer. In some embodiments, cutting glass-polymer laminate 100 comprises forming a notch in a first edge of the glass-polymer laminate and cutting the glass polymer laminate from a second edge opposite the first edge toward the notch.

In some embodiments, glass-polymer laminate 100 is bonded to a substantially flat surface at an installation temperature that is less than the lamination temperature or at most about 5° C. greater than the lamination temperature. For example, the substantially flat surface comprises a wall, a ceiling, a floor, a countertop or benchtop, a tabletop, or another suitable surface. In some embodiments, the installation temperature is at least about 16° C. For example, the installation temperature is about 16° C. to about 40° C. or about 16° C. to about 35° C. Installing glass-polymer laminate at the installation temperature between about 16° C. and the lamination temperature can help to ensure that the bow flattening force is sufficiently low (e.g., at most about 150 N) for installation and glass layer 110 is in compression during the installation to avoid breaking the glass layer. In some embodiments, bonding glass-polymer laminate 100 to the substantially flat surface comprises applying a first adhesive and a second adhesive between the glass-polymer laminate and the substantially flat surface and maintaining the glass-polymer laminate in position on the substantially flat surface with the first adhesive while allowing the second adhesive to cure. For example, the first adhesive comprises a pressure sensitive adhesive. Additionally, or alternatively, the second adhesive comprises a silicone-based adhesive. Maintaining glass-polymer laminate 100 in position with the pressure sensitive adhesive can enable the silicone-based adhesive to cure to fix the glass-polymer laminate in place on the substantially flat surface.

### EXAMPLES

### Comparative Example

A glass-polymer laminate having the general structure shown in FIG. 1 was formed by laminating a polymer layer to a glass layer with an adhesive layer using a S2S lamination process and a lamination temperature of about 22° C. The glass layer was formed from an alkaline earth boroaluminosilicate glass with a CTE of 3.2×10⁻⁶° C.⁻¹ and an elastic modulus of 74 GPa. The polymer layer was formed from PMMA with a CTE of about 75×10⁻⁶° C.⁻¹ and an elastic modulus of 3 GPa. The adhesive layer was formed from an optically clear pressure sensitive adhesive with a lower elastic modulus than the polymer layer. The glass layer had a thickness of 200 μm. The polymer layer had a thickness of 5.6 mm. The adhesive layer had a thickness of 50 μm. The glass-polymer laminate was rectangular in shape and had a width of 920 mm and a length of 2620 mm.

The glass-polymer laminate was cut with a handheld power tool, resulting in a significant change in the strength of the glass layer from its pre-lamination condition. Cutting with a router or table saw resulted in a B₁₀ glass edge strength of about 20 MPa measured using 100 mm×50 mm four-point bend specimen. Adjusting this strength for size statistics and glass fatigue reduced the B₁₀ glass edge strength to about 5 MPa. Adding a finishing step to the cut edge improved the B₁₀ edge strength to about 70 MPa. Adjusting this strength for size statistics and glass fatigue reduced the B₁₀ glass edge strength to about 12 MPa.

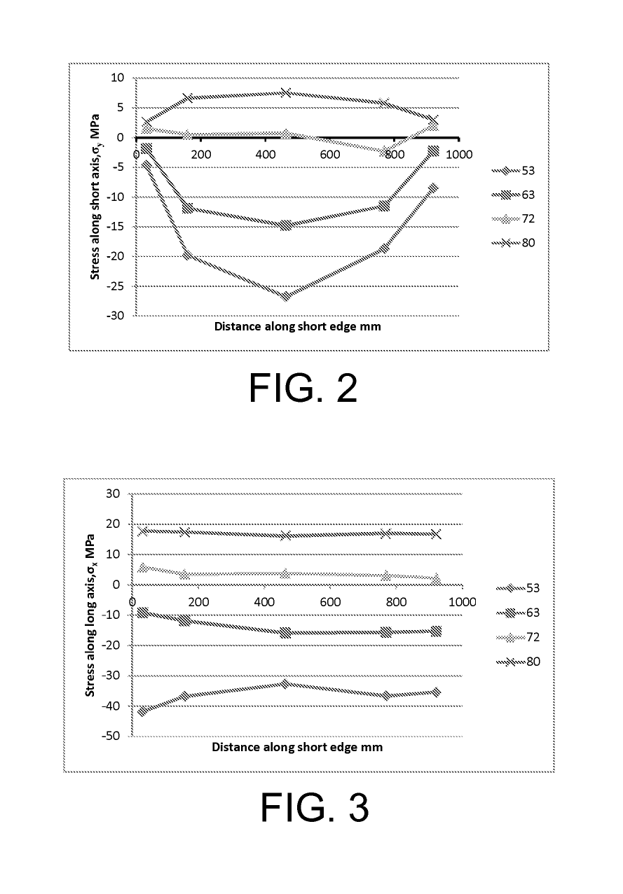

Stresses in the glass layer were measured in two orthogonal directions at multiple points along the short centerline of the glass-polymer laminate. The maximum stress value in each direction was found to be in the center of the laminate. FIG. 2 is a graphical illustration of the stress in the glass layer in the direction of the short axis as a function of position along the short centerline of the glass-polymer laminate at multiple temperatures. FIG. 3 is a graphical illustration of the stress in the glass layer in the direction of the long axis as a function of position along the short centerline of the glass-polymer laminate at multiple temperatures. In FIGS. 2-3, negative values represent compressive stress, and positive values represent tensile stress.

As shown in FIG. 2, the stress in the direction orthogonal to an edge approach zero as the position along the centerline approaches that edge. As shown in FIG. 3, the stress in the direction parallel to the edge are less likely to decrease as the position along the centerline approaches that edge. FIG. 2 shows a stress sensitivity to temperature of about 2.4 MPa/° C., and FIG. 3 shows a stress sensitivity of about 3.3 MPa/° C. Experimental values ranged from 2 MPa/° C. to 4 MPa/° C. Analytical modeling and finite element modeling agreed well with the experimental values, showing sensitivities of about 3 MPa/° C., and depended significantly on input properties such as CTE and elastic modulus of the PMMA.

A potential problem with such stress sensitivity to temperature is that a 2° C. increase in temperature of the glass-polymer laminate above the lamination temperature can generate enough stress to fracture the glass layer, and a 4° C. increase in temperature of the glass-polymer laminate above the lamination temperature can generate enough stress to fracture the glass layer with a finished edge at some point during its life.

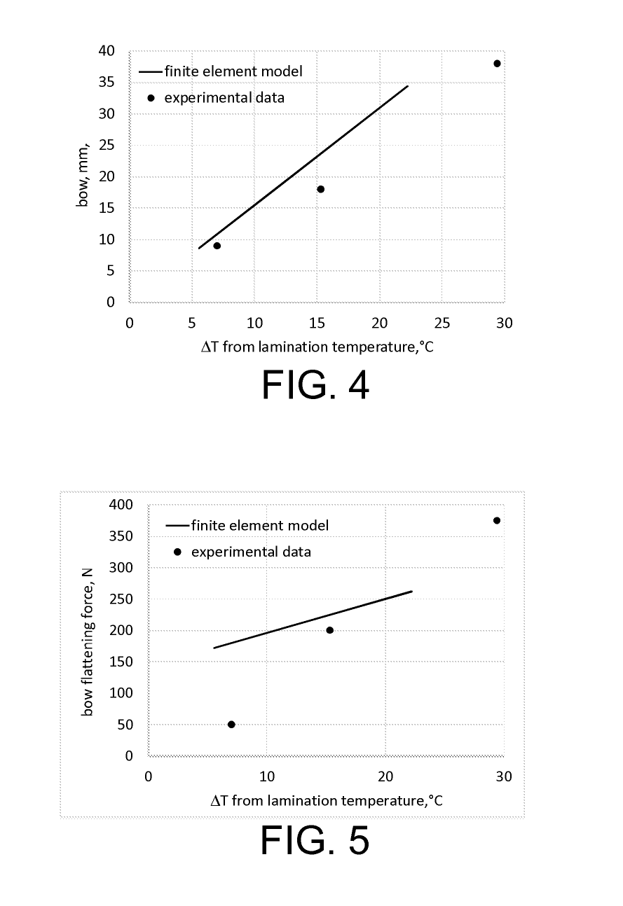

The temperature of the glass-polymer laminate was reduced below the lamination temperature, causing the PMMA to shrink more than the glass and resulting in bowing of the laminate. Unexpectedly, the bowing occurred about the long axis of the laminate as opposed to the short axis. The bowing was modeled using a finite element model. The model was constrained to force the bowing to occur in the same direction as observed experimentally. FIG. 4 is a graphical illustration of the bow in the glass-polymer laminate as a function of ΔT from the lamination temperature, or the difference between the lamination temperature and the temperature of the glass-polymer laminate at which the bow was measured. The line represents the results of the finite element model predicting the bow using a value of 1300 MPa for the elastic modulus of the PMMA, as opposed to the experimental value of 3000 MPa. The higher modulus results in a stiffer glass-polymer laminate and a smaller amount of bowing as indicated by the data points shown in FIG. 4. The model showed a bow sensitivity to ΔT of about 1.6 mm/° C., and the experimental data showed a bow sensitivity to ΔT of about 1.3 mm/° C.

FIG. 5 is a graphical illustration of the bow flattening force of the glass-polymer laminate as a function of ΔT from the lamination temperature. The experimental data was determined by placing weights on the glass-polymer laminate to flatten the glass-polymer laminate. The data point in the upper right corner of the graph indicates that the bow was not completely removed when the maximum available force was applied. The line represents the results of the finite element model predicting the bow flattening force. The model shows a bow flattening force sensitivity to ΔT of about 5.4 N/° C., and the experimental data shows a bow flattening force sensitivity to ΔT of >14 N/° C. As the bow flattening force increased above 150 N, mounting the glass-polymer laminate to a wall with adhesive tape became exceedingly difficult.

It can be beneficial for the glass-polymer laminate to have a high temperature cutting and installation limit of at least 35° C., a low temperature installation limit of at most 16° C., and/or a low temperature life limit of at most 0° C. as described herein.

The glass-polymer laminate of the Comparative Example, which was laminated at 22° C., would have 65 MPa of tensile stress in the glass layer at the high temperature cutting and installation limit, which is likely to cause the glass layer to break either during cutting or prior to cutting. The glass-polymer laminate of the Comparative Example would have a bow flattening force above 250 N at the low temperature installation limit, which is likely to make installation of the glass-polymer laminate difficult.

### Example 1

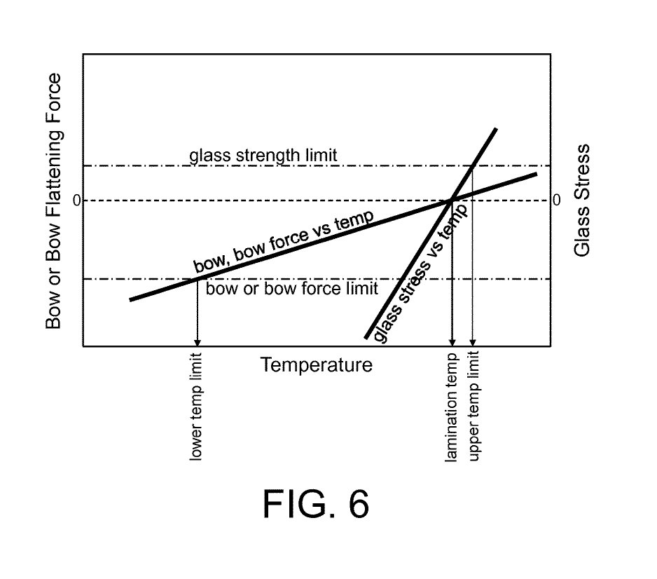

FIG. 6 is a graphical illustration of the temperature limits of the glass-polymer laminate and the relationship between the temperature limits and stress and bowing limits. The properties (e.g., CTE or elastic modulus) of the glass layer and/or the polymer layer; the dimensions of the glass layer, the polymer layer, and/or the glass-polymer laminate; and/or the lamination conditions (e.g., lamination temperature) can be adjusted to change the slopes of the bowing and stress lines and achieve the desired cutting, installation, and/or life temperature windows.

A glass-polymer laminate having the general structure shown in FIG. 1 was formed by laminating a polymer layer to a glass layer with an adhesive layer using a S2S lamination process and a lamination temperature of about 35° C. The glass layer was formed from an alkaline earth boroaluminosilicate glass with a CTE of 3.2×10⁻⁶° C.⁻¹ and an elastic modulus of 74 GPa. The polymer layer was formed from PMMA with a CTE of about 75×10⁻⁶° C.⁻¹ and an elastic modulus of 3 GPa. The adhesive layer was formed from an optically clear pressure sensitive adhesive with a lower elastic modulus than the polymer layer. The glass layer had a thickness of 200 μm. The polymer layer had a thickness of 5.6 mm. The adhesive layer had a thickness of 50 μm. The glass-polymer laminate was rectangular in shape and had a width of 690 mm and a length of 2620 mm. Thus, the glass-polymer laminate of Example 1 differed from the glass-polymer laminate of the Comparative Example in that the lamination temperature was 35° C., as opposed to 22° C., and the width was 690 mm, as opposed to 920 mm.

The lamination temperature was controlled using a laminating apparatus configured to heat the polymer layer during lamination to the glass layer. The polymer layer and the glass layer were advanced in a laminating direction along intersecting paths to bring the polymer layer and the glass layer together with the adhesive layer between the polymer layer and the glass layer. The conveying apparatus on which the polymer layer was advanced included convection heaters and infrared (IR) heaters directed toward the polymer layer to heat the polymer layer to the lamination temperature prior to lamination with the glass layer.

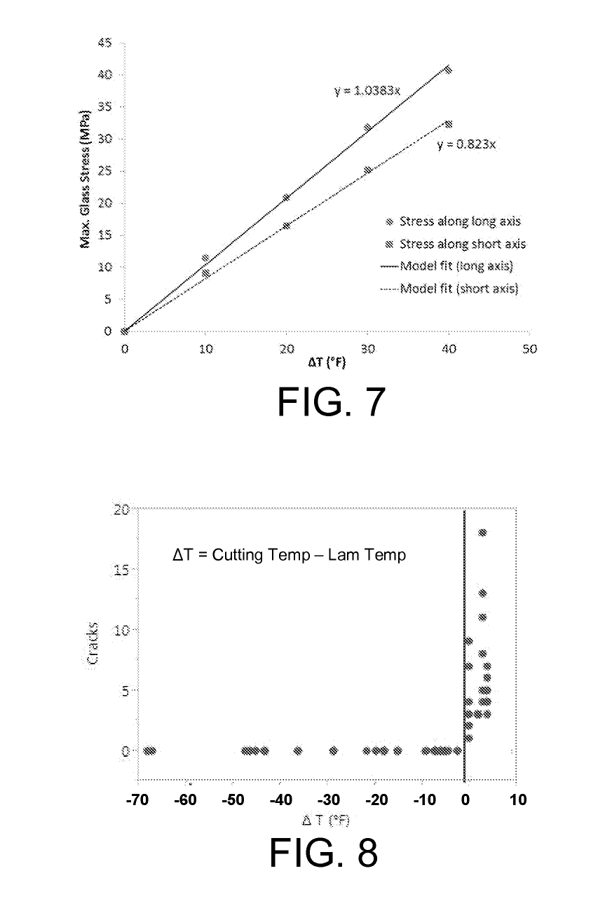

Table 1 shows the maximum compressive stress in the glass layer, the bow of the glass-polymer laminate, and the bow flattening force of the glass-polymer laminate at temperatures of 35° C., 22° C., 16° C., and 0° C. FIG. 7 is a graphical illustration of the maximum compressive stress in the glass layer of the glass-polymer laminate along each of the long axis and the short axis as a function of ΔT from the lamination temperature. As shown in Table 1 and FIG. 7, at all temperatures from 16° C. to 35° C., the glass layer comprises a compressive stress (or zero stress at 35° C.). Also as shown in Table 1, at all temperatures from 16° C. to 35° C., the glass-polymer laminate comprises a bow flattening force of at most 140 N.

TABLE 1
Glass-Polymer Laminate Properties

| | Maximum Glass | | Laminate Bow |
|---|---|---|---|
| Temperature | Compressive Stress | Laminate Bow | Flattening Force |
| 35° C. | 0 | 0 | 0 |
| 22° C. | 22-27 MPa | 11-14 mm | 80-120 N |
| 16° C. | 33-39 MPa | 17-20 mm | 110-140 N |
| 0° C. | 63-71 MPa | 32-35 mm | 280-350 N |

FIG. 8 is a graphical illustration of the number of cracks per part during cutting of the glass-polymer laminate of Example 1 as a function of ΔT from the lamination temperature. Each point represents one glass-polymer laminate part. As shown in FIG. 8, keeping the glass under compressive stress during cutting helps to avoid cracking the glass layer of the glass-polymer laminate.

Comparing the glass-polymer laminate of Example 1 to the glass-polymer laminate of the Comparative Example, increasing the lamination temperature resulted in the glass layer in Example 1 being in compression at all temperatures below 35° C., which encompasses the target range of 16° C. to 35° C. Increasing the lamination temperature further is possible, but doing so will result in increased bow, which can make installation of the glass-polymer laminate more difficult. Surprisingly, decreasing the width of the glass-polymer laminate reduced the stress sensitivity to temperature from about 3 MPa/° C. in the Comparative Example to about 1.9 MPa/° C. in Example 1 and reduced the bow sensitivity from about 1.4 mm/° C. in the Comparative Example to about 0.9 mm/° C. in Example 1. Such reduced sensitivity can enable cutting and installation of the glass-polymer laminate of Example 1 over a wider range of temperatures compared to the glass-polymer laminate of the Comparative Example.

### Example 2

A glass-polymer laminate having the general structure shown in FIG. 1 was formed by laminating a polymer layer to a glass layer with an adhesive layer using a S2S lamination process and a lamination temperature of about 22° C. The glass layer was formed from an alkaline earth boroaluminosilicate glass with a CTE of 3.2×10⁻⁶° C.⁻¹ and an elastic modulus of 74 GPa. The polymer layer was formed from PMMA with a CTE of about 75×10⁻⁶° C.⁻¹ and an elastic modulus of 3 GPa. The adhesive layer was formed from an optically clear pressure sensitive adhesive with a lower elastic modulus than the polymer layer. The glass layer had a thickness of 200 μm. The polymer layer had a thickness of 5.6 mm. The adhesive layer had a thickness of 50 μm. The glass-polymer laminate was rectangular in shape and initially had a width of 965 mm and a length of 2620 mm. The glass-polymer laminate was cut down progressively to sizes of 650 mm×2620 mm, 650 mm×2000 mm, 650 mm×1000 mm, and 650 mm×620 mm.

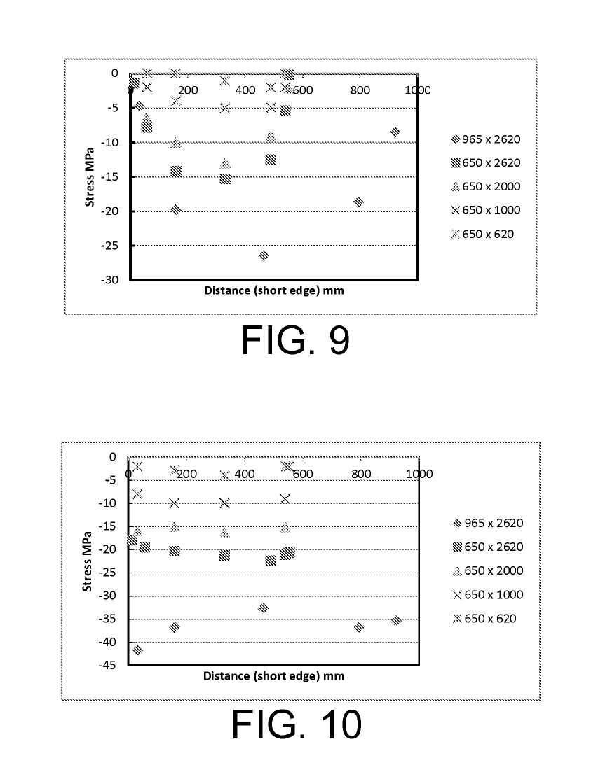

FIG. 9 is a graphical illustration of the stress in the glass layer in the direction of the short axis as a function of position along the short centerline of the glass-polymer laminate at the different sizes of the glass-polymer laminate. FIG. 10 is a graphical illustration of the stress in the glass layer in the direction of the long axis as a function of position along the short centerline of the glass-polymer laminate at the different sizes of the glass-polymer laminate. In FIGS. 9-10, negative values represent compressive stress, and positive values represent tensile stress. As shown in FIGS. 9-10, reducing the width of the glass-polymer laminate from 965 mm to 650 mm reduced the stress, and thus the stress sensitivity, in both directions by about 45%.

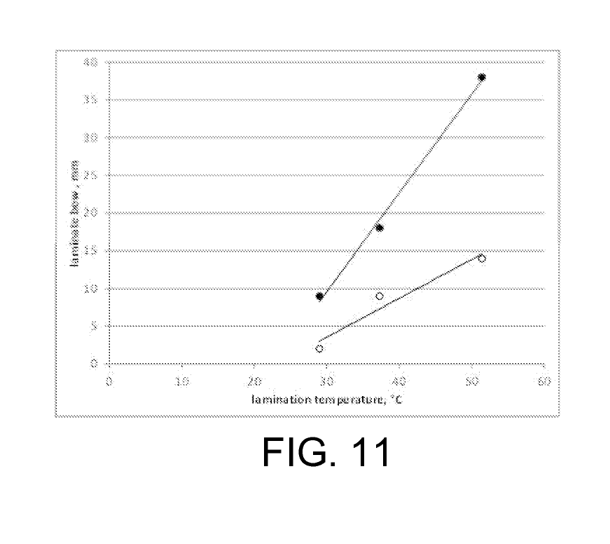

FIG. 11 is a graphical illustration comparing the bow of glass-polymer laminates measured at 22° C. as a function of lamination temperature for two different sizes of glass-polymer laminates. The black circles represent larger glass-polymer laminates having the same dimensions as the Comparative Example (920 mm×2620 mm), and the white circles represent smaller glass-polymer laminates having the same dimensions as Example 1 (650 mm×2620 mm). The glass-polymer laminates were formed generally as described in the Comparative Example and Example 1, respectively, except that the lamination temperature was varied. As illustrated by FIG. 11, reducing the width of the glass-polymer laminate reduces the sensitivity of the bow to lamination temperature.

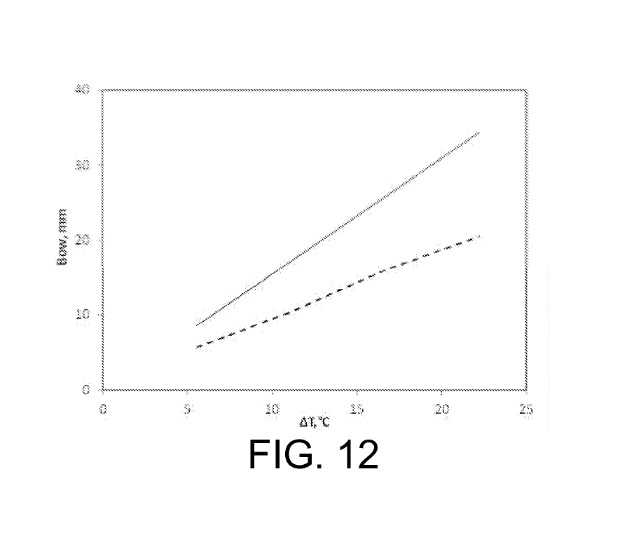

FIG. 12 is a graphical illustration comparing modeled bow of glass-polymer laminates as a function of ΔT from the lamination temperature for two different sizes of glass-polymer laminates. The solid line represents the larger glass-polymer laminate having the same dimensions as the Comparative Example (920 mm×2620 mm), and the dashed line represents the smaller glass-polymer laminate having the same dimensions as Example 1 (650 mm×2620 mm). As illustrated by FIG. 12, reducing the width of the glass-polymer laminate reduces the sensitivity of the bow to ΔT from the lamination temperature.

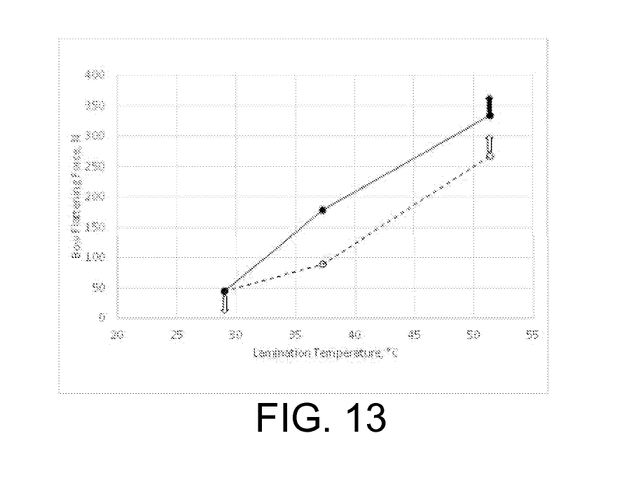

FIG. 13 is a graphical illustration comparing modeled bow flattening force measured at 22° C. as a function of lamination temperature for two different sizes of glass-polymer laminates. The solid line represents the larger glass-polymer laminate having the same dimensions as the Comparative Example (920 mm×2620 mm), and the dashed line represents the smaller glass-polymer laminate having the same dimensions as Example 1 (650 mm×2620 mm). As illustrated by FIG. 13, reducing the width of the glass-polymer laminate reduces the sensitivity of the bow flattening force to lamination temperature.

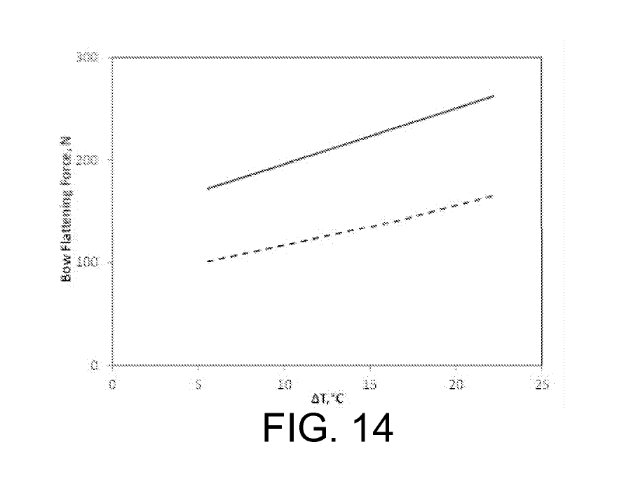

FIG. 14 is a graphical illustration comparing modeled bow flattening force of glass-polymer laminates as a function of ΔT from the lamination temperature for two different sizes of glass-polymer laminates. The solid line represents the larger glass-polymer laminate having the same dimensions as the Comparative Example (920 mm×2620 mm), and the dashed line represents the smaller glass-polymer laminate having the same dimensions as Example 1 (650 mm×2620 mm). As illustrated by FIG. 14, reducing the width of the glass-polymer laminate reduces the sensitivity of the bow flattening force to ΔT from the lamination temperature.

Cutting and installation of larger laminates (e.g., 1.5 m×3.0 m) over the temperature range of 16° C. to 35° C. can be enabled by adjusting the properties of the glass-polymer laminate. For example, decreasing the thickness of the polymer layer, increasing the thickness of the glass layer, decreasing the CTE of the polymer layer, and/or increasing the CTE of the glass layer can decrease the sensitivity of bow flattening force and glass stress to temperature with the primary effect of enabling cutting at the high temperature limit of 35° C. and/or installation at the low temperature limit of 16° C.

Modeling has predicted that decreasing the PMMA thickness of a glass-polymer laminate from 5.6 mm to 3.0 mm for a 690 mm×2620 mm product would have a significant effect on glass stress, bow magnitude, and bow flattening force. The sensitivity of glass stress to temperature drops by about 25%, the sensitivity of bow to temperature increases by about 67%, and the bow flattening force decreases by about 55%. In particular, such a decrease of the bow flattening force has a significant impact in widening the operational window and enabling larger size glass-polymer laminates.

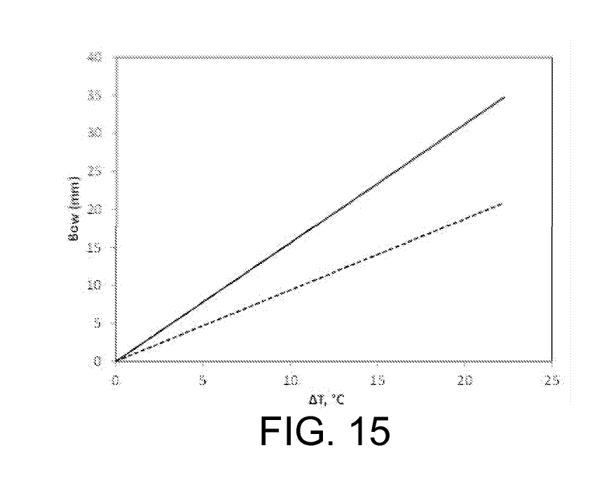

FIG. 15 is a graphical illustration comparing modeled bow of glass-polymer laminates as a function of ΔT from the lamination temperature for two different thicknesses of the polymer layer. The dashed line represents the thicker PMMA layer as described in the glass-polymer laminates of the Comparative Example and Example 1 (5.6 mm), and the solid line represents a thinner PMMA having a thickness of 3 mm. As shown in FIG. 15, the bow of the glass-polymer laminate with the thinner PMMA layer increases substantially more than that of the glass-polymer laminate with the thicker PMMA layer with increasing ΔT from the lamination temperature.

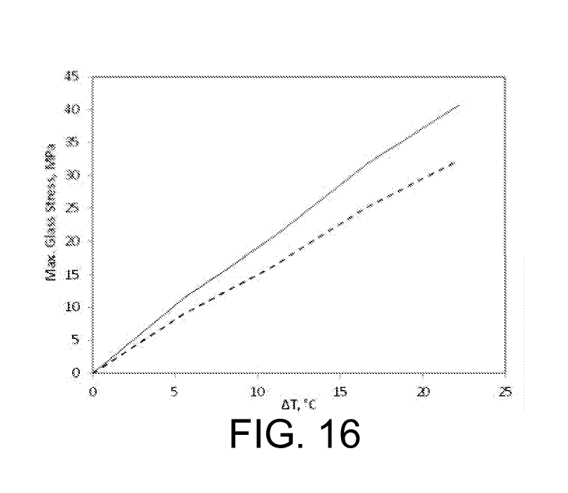

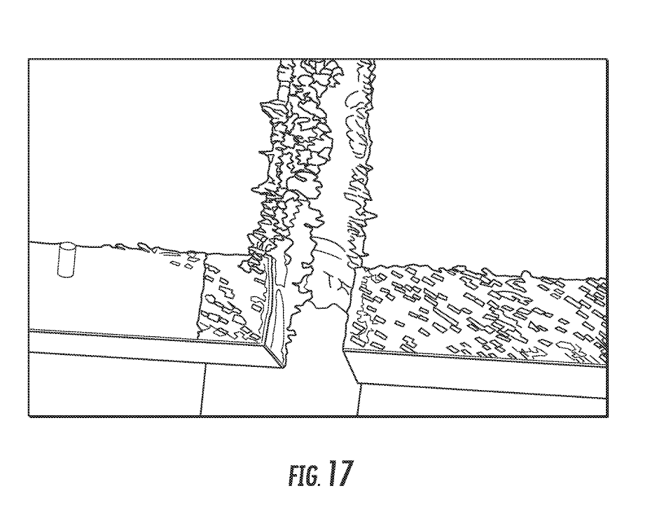

FIG. 16 is a graphical illustration comparing modeled maximum stress of glass layers of glass-polymer laminates as a function of ΔT from the lamination temperature for two different thicknesses of the polymer layer. The solid line represents the thicker PMMA layer as described in the glass-polymer laminates of the Comparative Example and Example 1 (5.6 mm), and the dashed line represents a thinner PMMA having a thickness of 3 mm. As shown in FIG. 16, the compressive stress of the glass layer is substantially less (e.g., about 23% to about 27% less) in the glass-polymer laminate with the thinner PMMA layer compared to the glass-polymer laminate with the thicker PMMA layer.

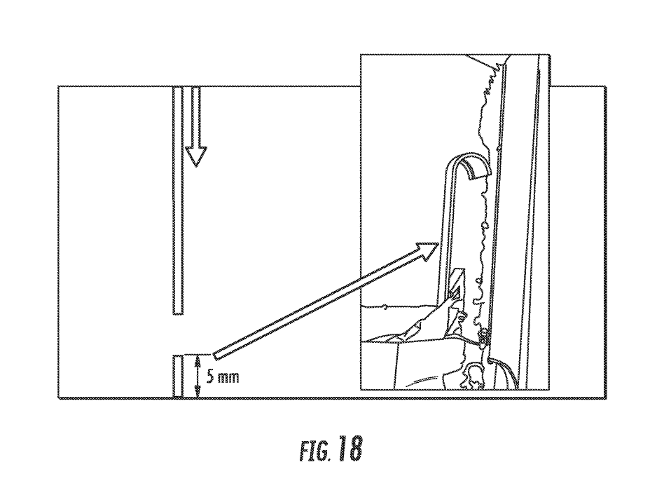

A glass-polymer laminate formed as described in Example 1 was cut in the direction of the short axis from a first edge using a router. As the cut approached a second edge opposite the first edge, exit cracking occurred near the cut. FIG. 17 is a photograph showing the finished cut and the exit cracking. Without wishing to be bound by any theory, it is believed that a tensile stress was formed in the glass layer as the router approached the second edge of the glass-polymer laminate, resulting in the exit cracking. The exit cracking occurred when compressive stress, measured at the center of the glass-polymer laminate, exceeded 20 MPa.

Another glass-polymer laminate formed as described in Example 1 was cut in the direction of the short axis using a router. A notch was formed in the first edge. The notch extended from the first edge along a cut line along which the glass-polymer laminate was intended to be cut. The notch extended entirely through the thickness of the glass-polymer laminate. The notch had a length measured from the first edge along the cut line of about 5 mm. FIG. 18 is a photograph showing the notch in the glass-polymer laminate. The glass-polymer laminate was cut along the cut line from the second edge toward the notch such that the cut ended at the notch. No exit cracking was observed near the cut. Without wishing to be bound by any theory, it is believed that the notch helped to form a compressive stress in the glass layer as the router approached the first edge of the glass-polymer laminate to help avoid exit cracking.

In some embodiments, the lamination temperature can be sufficiently high and the cutting temperature can be sufficiently low that the polymer layer is likely to break during cutting. For example, it has been observed in some embodiments that, when the lamination temperature is above about 40° C., at a cutting temperature of 16° C., the polymer layer is under sufficient tensile stress that it breaks during cutting.

It will be apparent to those skilled in the art that various modifications and variations can be made without departing from the spirit or scope of the invention. Accordingly, the invention is not to be restricted except in light of the attached claims and their equivalents.

1. A bowed glass-polymer laminate comprising:
a glass layer comprising a thickness of at most about 300 μm; and
a polymer layer laminated to the glass layer;
wherein, at all temperatures within a temperature range of about 16° C. to about 32° C., the glass layer comprises a compressive stress and the glass-polymer laminate comprises a bow flattening force of at most about 150 N.

2. The glass-polymer laminate of claim 1, wherein the glass-polymer laminate is capable of surviving cutting with a handheld power tool at a cutting temperature of about 32.2° C.

3. The glass-polymer laminate of claim 1, further comprising a width of about 640 mm to about 740 mm and a length of about 2570 mm to about 2670 mm.

4. The glass-polymer laminate of claim 1, wherein the polymer layer comprises a thickness of about 2.9 mm to about 6.1 mm.

5. The glass-polymer laminate of claim 1, wherein the polymer layer comprises a thickness of about 3.9 mm to about 6.1 mm.

6. (canceled)

7. The glass-polymer laminate of claim 1, wherein the glass layer comprises an average coefficient of thermal expansion of about 2.7×10⁻⁶° C.⁻¹ to about 3.7×10⁻⁶° C.⁻¹.

8. The glass-polymer laminate of claim 1, wherein the polymer layer comprises an average coefficient of thermal expansion of about 74.5×10⁻⁶° C.⁻¹ to about 75.5×10⁻⁶° C.⁻¹.

9. The glass-polymer laminate of claim 1, wherein an average coefficient of thermal expansion of the glass layer and an average coefficient of thermal expansion of the polymer layer differ by at least about 10×10⁻⁶° C.⁻¹.

10. The glass-polymer laminate of claim 1, wherein the polymer layer comprises poly(methyl methacrylate) (PMMA).

11. A method comprising:
laminating a glass layer to a polymer layer with an adhesive at a lamination temperature to form a glass-polymer laminate, the glass layer comprising a thickness of at most about 300 μm;
wherein the lamination temperature is sufficiently high that, at all temperatures within a temperature range of about 16° C. to about 32° C., the glass layer comprises a compressive stress; and
wherein the lamination temperature is sufficiently low that, at all temperatures within the temperature range of about 16° C. to about 32° C., the glass-polymer laminate comprises a bow flattening force of greater than 0 N and at most about 150 N.

12. The method of claim 11, further comprising cutting the glass-polymer laminate with a handheld power tool at a cutting temperature that is less than the lamination temperature.

13. The method of claim 12, wherein the cutting step comprises forming a notch in a first edge of the glass-polymer laminate and cutting the glass polymer laminate from a second edge opposite the first edge toward the notch.

14. The method of claim 11, further comprising bonding the glass-polymer laminate to a surface at an installation temperature that is less than the lamination temperature or at most about 5° C. greater than the lamination temperature.

15. (canceled)

16. The method of claim 14, wherein:
the surface comprises a substantially flat surface; and
the bonding step comprises applying a first adhesive and a second adhesive between the glass-polymer laminate and the substantially flat surface and maintaining the glass-polymer laminate in position on the substantially flat surface with the first adhesive while allowing the second adhesive to cure.

17. The method of claim 16, wherein the first adhesive comprises a pressure sensitive adhesive.

18. The method of claim 16, wherein the second adhesive comprises a silicone-based adhesive.

19. The method of claim 14, wherein the installation temperature is about 16° C. to about 40° C.

20. (canceled)

21. The method of claim 11, wherein the lamination temperature is about 30° C. to about 45° C.

22. (canceled)

23. The glass-polymer laminate of claim 1, wherein each of the glass layer and the polymer layer is an exterior layer of the glass-polymer laminate.

24. The glass-polymer laminate of claim 1, wherein the glass-polymer laminate is free of each of a second glass layer and a second polymer layer.
